(19) United States
(12) Patent Application Publication
(10) Pub. No.: US 2024/0394566 A1
(43) Pub. Date: Nov. 28, 2024

(54) Method and System for Automatically Develop Rules for Agents Driving Device Behavior

(71) Applicant: Verses Technologies USA, Inc., Los Angeles, CA (US)

(72) Inventors: Ozan Catal, Ghent (BE); Mahault Albarracin, Montreal (CA); Riddhi Jain Pitliya, Oxford (GB); Tim Verbelen, Dendermonde (BE); Alexander D.D. Tschantz, West End (AU); Axel Constant Pruvost, Montreal (CA); Christopher L. Buckley, Brighton (GB); Alexander Kiefer, Arverne, NY (US); Sara K. Brazille, Montreal (CA); Magnus T. Koudahl, Eindhoven (NL); Jason G. Fox, Dallas, TX (US); Karl J. Friston, Rickmanswort (GB); Stephan A. Swanson, Culver City, CA (US); Capm S.S. Petersen, Los Angeles, CA (US); Gabriel Joseph Bradley Rene, Los Angeles, CA (US); Maxwell J. Ramstead, Montreal (CA)

(21) Appl. No.: 18/651,479

(22) Filed: Apr. 30, 2024

Related U.S. Application Data
(60) Provisional application No. 63/499,287, filed on May 1, 2023.

(51) Int. Cl. G06N 5/022

(52) U.S. Cl. CPC G06N 5/022

(57) ABSTRACT

A method and system for automatically converting a knowledge graph into a format that can be used to automatically develop rules for agents driving device behavior.

### FIELD OF INVENTION

The preset application deals with Artificial intelligence software

### BACKGROUND

Agent-based modeling is emerging as a popular approach to the design of artificial intelligence software systems. This approach involves the design and deployment of software systems known as Agents, which implement monitoring and control functions for devices able to act both in simulated and in real-world environments (e.g., controlling the flight of a drone in real-time). Agents function as software for devices of different kinds (e.g., a robot), and can be connected to the operating systems of devices to enable appropriate behavior. For purposes of this application, the term device and robot are used to define a physical or virtual robot or another device that acts in an environment to accomplish a task requested by a user. An agent defines the software controlling a device. Designing artificial intelligence software systems for new settings or task domains requires developing new software from the ground up, which is often a complex and challenging process. Developing new software requires explicitly defining the rules that will allow the agent to generate device behavior adapted to the task at hand.

### BRIEF DESCRIPTION OF THE DRAWINGS

FIG. 1 illustrates a flowchart of one embodiment of the invention, and

FIG. 2 is a depiction of one embodiment of a translation of an HSML graph into generative model parameters using the generative model method of the invention.

### SUMMARY OF THE INVENTION

The present invention provides a method and system for automatically creating an agent that will generate device behavior adapted to any task at hand. This is achieved by allowing the agent to learn structured knowledge contained in a knowledge graph, and translating the knowledge graph into the agent's knowledge encoded in a generative model. While in the prior art knowledge graphs are used to represent information about the context or situation in which a device will be deployed, such prior art provides no methods to automatically convert a knowledge graph into a format that can be used to automatically develop rules for agents driving device behavior. The claimed method allows for such automatic translation.

### Definitions

A knowledge graph represents entities in the world and the relationships between them. Entities are any physical or conceptual “thing” that has meaning in the real world (e.g., a robot, a sofa, a way point in space that refers to a location where one can go, a specification of an activity). Relationships between entities are expressed by links that explicit the relation between entities. The claimed method structures this information using a structured modeling language such as Hyperspace Modeling Language (HSML). HSML is a structured modeling language that specifies both the semantic and the action links between entities. The resulting model defines both the relationship between entities and the activities that an Agent can perform over those entities. An HSML graph is a special implementation of a knowledge graph that provides a semantic ontology by grouping entities as one of 5 HSML categories referred to as “primitives” (discussed further below). The knowledge about entities represented under the 5 HSML primitives is required for operating a spatial transaction. The claimed method allows for generating an Agent for a device (e.g., robot) able to use the knowledge contained in a HSML graph to perform spatial transactions (e.g., moving a box from location L1 to location L2).

A Hyperspace Transaction Protocol (HSTP) server is a server implementation of the Hyperspace Transaction Protocol (HSTP). The HSTP program is defined in HSML, and functions as the protocol for HSML. HSTP defines the types of transactions required to exchange all or part of a HSML knowledge model between hosts. One can read from and write to the HSML graph using the HSTP protocol. The HSTP server allows any HSTP client to operate any Create, Read, Update, and Delete (CRUD) operations on a HSML graph.

Active inference is an algorithm that applies to predictive statistical models known as generative models and can be used to generate predictions of input data (i.e., “what will happen next”) based on a set of underlying assumptions or Bayesian prior beliefs. As applied to a generative model, active inference allows for the generation of action plans to be performed based on predictions about future inputs. In one embodiment of the claimed method, generative models applying the active inference algorithm use a model structure known as Partially Observable Markov Decision Processes (POMDP). The generative model implemented as a POMDP and to which the active inference algorithm applies, functions as the Agent that allows a device to perform an activity. The generation of action plans by active inference Agents is achieved by their generative model by comparing the simulated or predicted input to the true received inputs, and by updating prior beliefs and choosing a course of action accordingly, to minimize the difference between the two. This difference is known as (variational or generalized) free energy. Active Inference can be used to simulate inference (i.e., inferring the causes of sensory data in short timescales), parameter learning (i.e., inferring the parameters of the generative model), and structure learning (i.e., learning the structure of the generative model). The POMDP is defined by 5 sets of parameters of the generative model, denoted A, B, C, D, and E, which represent different aspects of an agent's generative model. The A, B, C, D, and E parameters are written down as matrices or tensors (in higher dimensional cases) as follows. Each parameter is a matrix or tensor in the traditional sense: they are an array of numbers in two (matrix) or multiple (tensor) dimensions. These are stored as an array in a programming language (e.g., Python or Julia). A (the likelihood matrix tensor) represents the likelihood of observing (sensory) data given latent states. It connects data or content to the states that cause that data by modeling the mapping of hidden or latent states (causes) to the agent's input (consequences). In this invention, states and observations are both data that form elements of the HSML graph. B (the state Transition matrix or tensor) describes how states evolve over time; i.e., how one state transitions to the next state as a function of the agent's actions (e.g., the possibility of moving from location L1 to location L2). The agent uses the B matrix to predict how its actions will influence the future hidden states. C (the Prior Preference or Goal matrix or tensor) encodes the agent's goals in terms of the preferred data or observational outcomes. The agent uses the C matrix to evaluate the desirability of different future inputs, which helps guide its actions toward achieving its goals; i.e., satisfying constraints. D (the initial Prior State matrix) relates to the agent's beliefs about the current hidden states of the environment that contextualize state transitions. E (the Habit or Policy Prior matrix) encodes what the agent will tend to do by default.

The claimed method translates a HSML knowledge graph into an Agent software driven by a generative model implemented as a partially observable markov decision process (POMDP) able to perform state inference, policy selection, and input data prediction, using the inference algorithm of active inference according to the knowledge contained in the HSML knowledge graph.

The claimed method addresses limitations in prior arts by automating the conversion of a knowledge graph into an agent corresponding to a generative model that uses the algorithm of active inference rendering a device capable of acting appropriately in any given context described by a knowledge graph.

In one embodiment, the claimed method translates a knowledge graph made using the Hyperspace Modeling Language (HSML) representation of the real or virtual world, exposed through a Hyperspace Transaction Protocol (HSTP), into a POMDP based generative model, which functions as the main driver of a device for sensing and acting in the real or virtual world. The generative model can be used to control a device (e.g., a robot or Internet of Things (IoT) device) to perform a hyperspatial transaction (e.g., requesting a robot to move a box from location L1 to location L2). The features of the environment in which the hyperspatial transaction occurs are encoded as entities of the HSML graph and categorized as one of five HSML primitives forming the ontology of the HSML graph:
1. Domain: people, places, and things that perform activities (e.g., a box)
2. Space: Physical or conceptual spaces (e.g. volume, spectrum, colorspace, spacetime, UV space, temperature)
3. Activity: transformations that can be performed by Domains on other HSML entities (e.g., moving a box from space location L1 to L2)
4. Credential: Permissions and role definitions that provide security and constraints on Activities
5. Channel: Collection of Domains, Activities, Spaces, and Credentials e.g. Disney

The implementation of the claimed method is composed of the following elements:
1. A HSML graph with nodes and edges that stores knowledge about entities expressed as one or more of the 5 HSML primitives
2. An HSTP server that mediates Create, Read, Update, and Delete (CRUD) access to the HSML graph
3. An active inference Agent implemented as a POMDP generative model, in one embodiment of this invention, written as a class comprised of different methods in Python programing language, which includes, though is not limited to:
   a read method and a link method for reading information from a HSML graph through an HSTP server
   a generative model method for constructing a generative model out of the HSML graph information that uses the HSML ontology
   an inference method to moving a device by performing the inference of states and policies, and predict future input data using an active inference algorithm
   a write method, for updating the HSML graph based on inferred states, through the HSTP server, thereby allowing a device using an active inference driven Agent defining the software for performing an activity requested by a user and updating knowledge in the HSML graph

The elements of the claimed method are combined to form the following process:
1. A User issues a query to an Agent through the HSTP server in accordance with a contract (e.g., move a box from location L1 to location L2). The query is an activity primitive and a hyperspatial transaction.
2. Through the read method and a link method, the Agent issues a request to the HSTP server to query relevant information in the HSML graph, and the HSTP server sends back the HSML knowledge categorized as per the relevant primitives to the Agent as a response.
3. The HSML knowledge is automatically translated using the generative model method into the format expected by the model parameter of the Agent's generative model implemented as a POMDP, which is achieved by (i) identifying the query relevant knowledge in the HSML graph, with nodes of the graph representing the entities of relevance (e.g., “box” as an entity in the domain primitive) and with edges representing the relation of relevance between entities (e.g., the box “is_at” location L1), and by (ii) updating the Agent's model parameters in a way that reflects those relations between entities.
4. Once the activity has been performed by the device using the inference method, the Agent issues a second query to the HSTP server to update the HSML knowledge contained in the HSML graph, using the write method (e.g., verification that the box was successfully moved). This verification ensures the HSML graph is always up to date.

Thus, according to the invention, there is provided a method for translating an HSML graph into an Agent for controlling a device by means of an active inference algorithm to perform state and policy inference and input data prediction for controlling a device, comprising using a hyperspace modeling language (HSML) to define an HSML graph made of nodes and edges to define how entities in a domain space are related, and grouping those entities under 5 HSML primitives; defining an active inference agent written as a class comprised of methods in a dynamic programing language, which include a read method and a link method for reading data from a HSML graph through a CRUD functionality providing system using HSTP, a generative model method for constructing a generative model out of the HSML graph information that uses the HSML ontology, an inference method for controlling a device by performing the inference of states and policies, and predict future input data using an active inference algorithm, a write method, for updating the HSML graph based on inferred states, through the HSTP server, thereby allowing a device that uses an active inference driven Agent to define the software for performing an activity requested by a user and updating knowledge in the HSML graph.

The active inference Agent's generative model may be implemented, as a partially observable Markov decision process (POMDP) allowing the device to receive and predict input data and act in a physical or virtual environment, wherein the next environmental states are inferred based on current input data using the active inference algorithm.

The active inference algorithm may include one or more of: belief propagation, variational message passing, Laplace propagation and Expectation Propagation algorithms.

The HSML graph may be translated into a POMDP generative model to which an active inference algorithm applies, and that defines the Agent for the device capable of reasoning about how to perform user queried activities and capable of updating the HSML graph from which it derives its knowledge, based on environmental and user input data feedback.

### DETAILED DESCRIPTION

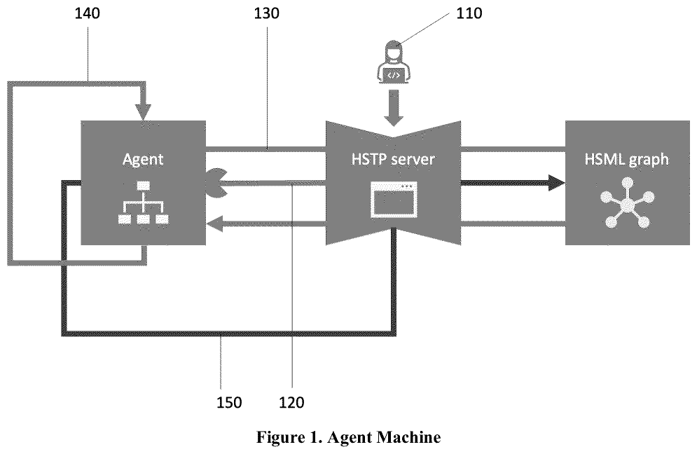

One implementation of an embodiment of the invention is shown in FIG. 1. The Agent is a class in the Python programming language and is composed of several methods. Sample pseudo code using the Python programming language for implementing the example discussed here, is interspersed here for ease of understanding. The pseudo code exemplifies how the different methods could be called in an Agent class in a Python programming language. 110 A user makes a request through the HSTP server for an activity (e.g., move the box from location L1 to location L2). This information is reported in Json format. It specifies the type of activity, the actor involved, and the success conditions.

```
# example user request for an activity
}
  “name”: “MoveObjectActivity”,
  “$schema”: “move_object_activity”,
  “actor”: “swid:entity:QdlgsDocjq_u0AMmR0ULl”,
  “parameters”: {
    “object”: “swid:entity:QdlgsDocjq_u0AMmR0ULl”,
    “location”: “swid:entity:vZ6-Sv0JtmU51cexeWP3h”
  },
  “conditions”: [
    {
      “$schema”: “condition_equals”,
      “arguments”: [
        “$object−>is_at.destination_swid”,
        “$location.swid”
      ]
    }
  ]
}
```

120 The Agent listens for the user's query through a Websocket. 130 A read method part of the Agent class is called to ask the HSTP server to read information about entities related to the activity on the HSML graph, which is returned to the Agent, in one embodiment of this invention, in Json format:

```
# get the HSML json of the entity with identifier swid
swid = “swid:entity:QdlgsDocjq_u0AMmR0ULl”
entity = read(swid)
# returns something like
{
  name : “box” (i.e., an entity)
  swid: “swid:entity:QdlgsDocjq_u0AMmR0ULl” (the entity ID)
  $schema: “thing” (i.e., reference to the primitive)
  ... (i.e., other related information)
}
```

A link method part of the Agent class is called to ask the HSTP server to read links information which is returned to the Agent in JSON format:

```
# get the links from/to the entity with identifier swid
links = readLinks(swid)
# returns a list of swids [“swid:entity:u4fxlI5M5Q_4A-j0f0iZW”] # that
refer to entities that resemble the links
# i.e.
read(“swid:entity:u4fxlI5M5Q_4A-j0f0iZW”)
{
  swid: “swid:entity:u4fxlI5M5Q_4A-j0f0iZW”
  $schema: “link”
  source: “swid:entity: QdlgsDocjq_u0AMmR0ULl” (this entity)
  destination: “swid:entity:krxu-liM3nlsttfGKUGjr” (a location)
  name: “is_at” (is at, goes to, etc.)
}
```

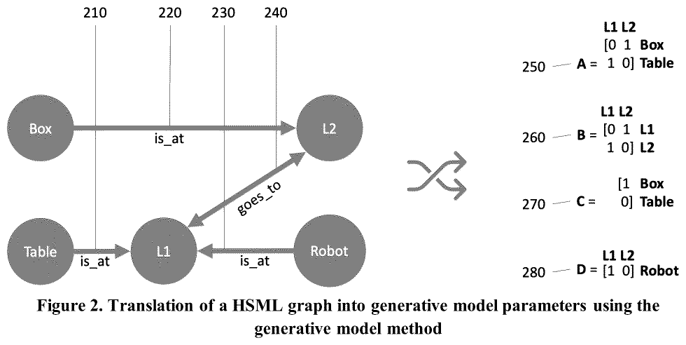

140 The requested information is translated into generative model parameters. This translation process is done through the operations of the generative model method of the Agent class. These operations are presented in FIG. 2. By way of illustration, the HSML graph using the HSML ontology of FIG. 2 contains the knowledge as edge and relating nodes. The nodes represent domain and space primitive entities (Box, Table, L1, L2, Robot). The edges represent the links, or types of relations between those entities (210, 220, 230, 240). Edges and nodes provide the sufficient information to translate the knowledge graph into generative model parameters (250, 260, 270, 280). One implementation of an embodiment of this translation process is depicted in FIG. 2, presenting a simple HSML graph using the HSML ontology for describing knowledge associated with the three domain entities. These entities are linked in the HSML graph to other space entities, which are locations L1 and L2 (e.g., locations in a warehouse). The links between these entities carry “name” information (e.g., a box “is_at” location L1) allowing for translating the knowledge graph into model parameters A, B, C, D, E of the generative model. This is achieved in the following way. In FIG. 2 (right hand side), the parameters are matrices, the columns of which represent a probability distribution. The A matrix or parameter maps the probability that each domain entity will be found at a space entity (e.g., a “box” can be found at “location L2”). If only one domain entity can be found at a location, then the probability of that entity at that location is 100%. This is denoted as 1 in the A matrix. The B matrix or parameter maps the probability of transitioning between space primitive entities. For instance, if there is a wall between location L1 and location L2, the B matrix will encode a 0% probability of moving between L1 and L2, denoted as 0 in the B matrix. The D matrix provides the initial space entity probability for the device implemented by the Agent (e.g., the robot). In the HSML graph presented in FIG. 2, the robot has 100% probability of starting at location L1 since there is no edge linking the robot node to the location L2. The C matrix specifics which of the domain entities the robot should prefer to go to. The C matrix is parameterized based on the user query. 210 The entity “table” is at location L1, and the edge 220 indicates that the entity “box” is at location L2. The edge 230 indicates that the robot domain entity is at location L1. The edge 240 indicates that it is possible to transition between location L1 and location L2, and vice versa. 250 the knowledge about domain entities box and table of the HSML graph and the links to their related space entities location L1 and L2 is translated into the A parameter (e.g., box is_at L2=100%, table is_at L1=100%, and box is_at L1=0%, and table is_at L2=0%). The robot entity is not part of the likelihood matrix A because its relation to L1 in the knowledge graph is used to parameterize the D parameter, and not the A parameter. 260 the knowledge about possible transition between space entities is translated into the B parameters. Because the arrow between L1 and L2 is bidirectional and because there is no arrow that goes from L1 to L1 or from L2 to L2, the probabilities of transitioning between L1 and L2, and from L2 and L1 are 100%, and other possible transitions have 0 probability. 270 The C parameter specifies the Agent's preference for possible domain entities and is defined by the user's query (e.g., pick a “box”). 280 The initial state vector D is specified by the location of the robot domain entity such as specified by the knowledge graph (i.e., 230 robot “is_at” location L1). 150 The update in model parameters is sent back to the HSML graph through the HSTP server to update the HSML graph as depicted by reference numerals in FIG. 1.

For purposes of this application, the term device and robot are used to define a physical or virtual robot or other device that acts in an environment to accomplish a task requested by a user. An agent defines the software controlling a device. While the application has been described with respect to specific implementations in using specific examples, it will be appreciated that the application is not so limited and can include variations without departing from the scope of the invention.

What is claimed is:

1. A method for translating a Structured Modeling Language (SML) graph into an Agent for controlling a device by means of an active inference algorithm to perform state and policy inference and input data prediction for controlling a device, comprising,
using an SML to define an SML graph made of nodes and edges to define how entities in a domain space are related, and grouping those entities under the SML primitives,
defining an active inference agent, which includes a read method and a link method for reading data from the SML graph through a system that includes CRUD (Create, Read, Update and Delete) functionality, using a Transaction Protocol (TP), a generative model method for constructing a generative model out of the SML graph information that uses the SML primitives, an inference method for controlling a device by performing the inference of states and policies and predict future input data using an active inference algorithm, a write method for updating the SML graph based on inferred states, thereby allowing a device that uses an active inference driven Agent to define the software for performing an activity requested by a user and updating knowledge in the SML graph.

2. The method of claim 1, wherein the active inference Agent's generative model is implemented, as a partially observable Markov decision process (POMDP) allowing the device to receive and predict input data and act in a physical or virtual environment, wherein the next environmental states are inferred based on current input data using the active inference algorithm.

3. The method of claim 2, wherein, the active inference algorithm includes one or more belief propagation, variational message passing, Laplace propagation and Expectation Propagation algorithms.

4. The method of claim 3, wherein the SML graph is translated into a POMDP generative model to which an active inference algorithm applies, and that defines the Agent for the device capable of reasoning about how to perform user queried activities and capable of updating the SML graph from which it derives its knowledge, based on environmental and user input data feedback.

5. A system for automatically developing rules for agents driving device behavior comprising software that includes,
a web socket capable of listening to a user query;
a read method capable of Create, Read, Update, and Delete (CRUD) functionality over a Structured Modelling Language (SML) graph through a server using a Transaction Protocol (TP), wherein information structured by the SML is encoded in an SML graph made of nodes and edges defining how the information is encoded, and
a link method capable of writing information from the SML graph according to the Transaction Protocol (TP) to the server hosting an agent computer software.

6. A system of claim 5, wherein,
a user query is in natural language and can come from a human user or another agent.

7. A method of parametrizing an agent, comprising,
translating information contained in a graph structured with a Structured Modelling Language (SML) into parameters of an agent generative model.

8. A method of claim 7, wherein the agent generative model is written as a class in a dynamic programming language, and the agent model is implemented as a Partially Observable Markov Decision Process with parameters in the form of matrices.

9. A method of claim 8, wherein,
cells of a matrix encode conditional probabilities about the relation between the information represented by the rows and columns of the matrix.

10. A method of claim 9, wherein at least one of the matrices is a 1-dimensional matrix with cells encoding the independent probability of the information encoded by each of the cells of the matrix.

11. A method of claim 10, wherein the cell encoding the information that corresponds to the user query is assigned the highest probability.

12. A method of controlling a device by means of an agent comprising,
creating a graph structured with a Structured Modelling Language (SML) that defines the relation between information contents with nodes and edges,
issuing a query using Create, Read, Update, and Delete (CRUD) functionality over the SML graph through a server using a Transaction Protocol (TP),
using an active inference algorithm to infer the controlled states that define the actions of the device controlled by the agent and capable of predicting future information contents, and
providing a write method capable of updating the SML graph based on the inferred controlled states.

13. A method of claim 12, wherein,
the active inference algorithm includes one or more inference schemes such as belief propagation, variational message passing, Laplace propagation and Expectation Propagation algorithms.
